(19) United States
(12) Patent Application Publication
(10) Pub. No.: US 2005/0214470 A1
(43) Pub. Date: Sep. 29, 2005

(54) Metal coating method excellent in corrosion resistance and article coated therewith

(76) Inventors: Akihiko Shimasaki, Kanagawa (JP); Hideki Iijima, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/810,706

(22) Filed: Mar. 29, 2004

(51) Int. Cl. B05D 3/02

(52) U.S. Cl. 427/384; 427/372.2

(57) ABSTRACT

A metal coating method excellent in corrosion resistance, which comprises: using a cationic coating composition containing a base resin and a curing agent; and forming a film onto such as a metal having a glass transition point (Tg) of from 60 to 95° C., and an oxygen permeability of from 5×10⁻¹³ (cc·cm/cm²·sec·cmHg) to 5×10⁻¹¹ (cc·cm/cm²·sec·cmHg) at a film thickness of 20 μm. The base resin is a xylene-formaldehyde-resin-modified amino-containing epoxy resin obtained by reacting an epoxy resin (1) having an epoxy equivalent of from 180 to 2500 with a xylene formaldehyde resin (2) and an amino-containing compound (3). The curing agent is a blocked polyisocyanate compound obtained by blocking an isocyanate group of a polyisocyanate compound with a blocking agent.

### TECHNICAL FIELD OF THE INVENTION

The present invention relates to a metal coating method using a cationic coating composition capable of forming a film excellent in corrosion resistance even if the film is formed by applying the composition to a metal object such as an automotive steel sheet and does not contain a harmful metal such as lead or chromium; and an article coated with this coating composition.

### DESCRIPTION OF RELATED TECHNOLOGY

Since cationic coating compositions can form a film excellent in corrosion resistance and surface smoothness, they have been used widely for rust-inhibitive coating of automotive bodies and parts. Owing to switchover to lead-free cationic coating compositions in consideration of the influence on environments, however, even the corrosion resistance of the cationic coating compositions tends to lower. The reason for this lowering is not completely known yet.

Japanese Patent Laid-Open No. 2000-7960 discloses a method of improving the exposure corrosion resistance of a film of a lead-free cationic electrodeposition coating, use of an electrodeposition coating composition capable forming a cured film having a thermal shrinkage stress at 40° C. of from 100 to 120 kg weight/cm², a Tg of from 70 to 90° C. and an impedance of 10⁸ Ω·cm² or greater is proposed.

Although the exposure corrosion resistance is improved by using an amine-added epoxy resin or amine-added ε-caprolactone-modified epoxy resin as a base resin in the above-described invention, no description is included concerning general corrosion resistance (for example, wet corrosion such as salt spray or hot salt-water immersion). A range of the characteristics of the coating film for improving corrosion resistance and kind of the base resin or curing agent for attaining these characteristics and thereby good corrosion resistance are not understood well.

### SUMMARY OF THE INVENTION

In order to improve the corrosion resistance of the coating film, the amount of an anti-corrosive pigment is increased to reinforce the inhibiting capacity against corrosion forming substances (such as oxygen, chlorine and alkali metals), or the amount of a catalyst is increased to improve crosslink density of the coating film and thereby heighten its permeation inhibiting capacity against the corrosion forming substances. Owing to the insufficient understanding of the physical properties of the coating film, however, corrosion inhibiting effects are not satisfactory and a deterioration in the finish property of the coating film, lowering in coating stability, and cost increase sometimes occur, depending on the variations in the coating conditions or state of the coating composition. There is accordingly a demand for understanding of the physical properties of the coating film excellent in corrosion resistance, a metal coating method using a cationic coating composition effective for attaining such physical properties, and articles coated thereby.

The present invention relates to a metal coating method excellent in corrosion resistance, which comprises: using a cationic coating composition containing a base resin and a curing agent; and forming a film onto such as a metal having a glass transition point (Tg) of from 60 to 95° C., and an oxygen permeability of from 5×10⁻¹³ (cc·cm/cm²·sec·cmHg) to 5×10⁻¹¹ (cc−cm/cm²·sec·cmHg) at a film thickness of 20 μm.

The base resin above may be a base resin (I), that is a xylene-formaldehyde-resin-modified amino-containing epoxy resin obtained by reacting an epoxy resin (1) having an epoxy equivalent of from 180 to 2500 with a xylene formaldehyde resin (2) and an amino-containing compound (3). The curing agent may be a curing agent (I), that is a blocked polyisocyanate compound obtained by blocking an isocyanate group of a polyisocyanate compound with a blocking agent.

Alternatively, the base resin may be a base resin (II), that is a polyol-modified amino-containing epoxy resin obtained by reacting an epoxy resin (1) having an epoxy equivalent of from 180 to 2500 with an amino-containing compound (3), and a polyol compound (4) available by adding a caprolactone to a compound having a plurality of active hydrogen groups, may be used.

Further alternatively, the base resin may be a base resin (III) that is a polyol-modified amino-containing epoxy resin (III) obtained by reacting an epoxy resin (1) having an epoxy equivalent of from 180 to 2500 with an alkyl phenol (v₁) and/or a carboxylic acid (v₂), an amino-containing compound (3) and a polyol compound (4) available by adding a caprolactone to a compound having a plurality of active hydrogen groups.

The curing agent may be a block polyisocyanate curing agent (II) obtained by reacting an active-hydrogen-containing component further containing propylene glycol with an aromatic polyisocyanate compound is incorporated as the whole or portion of the curing agent of the cationic coating composition.

The cationic coating composition of the present invention may be applied to an object to be coated to form a film having an adhesive force of 3.0 kg/cm² or greater. The cationic coating composition used for the metal coating method may contain at least one bismuth compound.

### BRIEF DESCRIPTION OF THE DRAWINGS

FIG. 1 is a graph showing the way how to find a glass transition point.

FIG. 2 illustrates a model of the electrode and wiring for measurement of oxygen permeability

FIG. 3 illustrates a jig used for the adhesion test.

### DETAILED DESCRIPTION OF THE INVENTION

The present invention is related to a metal coating method, of a cationic coating composition capable of forming a cured film having a glass transition point (Tg) of from 60 to 95° C., an oxygen permeability of from 5×10⁻¹³ (cc·cm/cm²·sec·cmHg) to 5×10⁻¹¹ (cc·cm/cm²·sec·cmHg) at a film thickness of 20 μm, and adhesive of from 3.0 kg/cm² or greater, preferably 4.7 kg/cm² or greater.

This method makes it possible to form a coating film of the cationic coating composition free of harmful metals such as lead and chromium, which are harmful in environmental protection, and contributing to the improvement in corrosion resistance. The present invention will hereinafter be described more specifically.

Glass Transition Point (Tg)

Polymer materials including coating films become soft at high temperatures, but they become very hard at a certain temperature or less. The term “glass transition point” means a temperature at which a material transits from a soft (rubber) state to a hard (glass) state by a temperature change from low to high.

The glass transition point was measured in the following manner:

(1) Preparation of a test plate: A tin plate (JIS G3303 SPTE; product of Nippon Test Panel Industry) of 0.3×150×70 mm was dipped in a cationic electrodeposition coating. With the plate as a cathode, electrodeposition coating was performed at a voltage of 150V for 3 minutes, followed by washing with water. By baking at 170° C. for 20 minutes in an electric hot-air dryer, a coated tin plate with a 20 μm-thick film was prepared.

(2) Preparation of an isolated film: The coated tin plate thus obtained was cut partially by a cutter knife and a drop of mercury was placed on the exposed surface of the tin plate to amalgamate it. The coating film was then peeled off by a pair of tweezers and cut into a piece of 5×30 mm by a cutter knife to prepare a test piece.

(3) The test piece was installed to “RS-20C” (trade name of glass transition point measuring apparatus manufactured by RHESKA) so that a length to be measured be 20 mm and its glass transition point was measured.

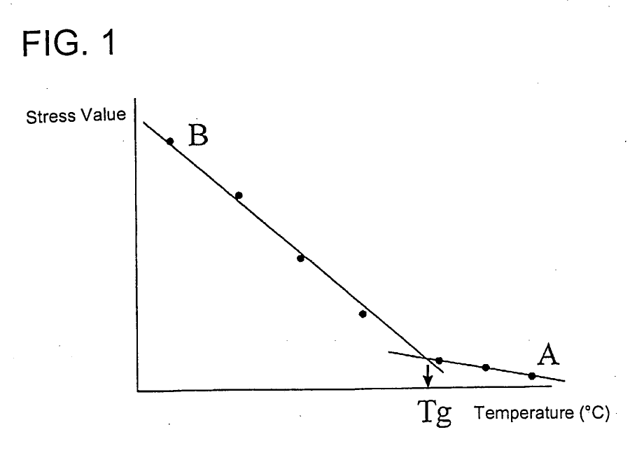

A stress value measured at the atmospheric temperature of 105° C. was adjusted to 0 kg weight and the temperature was lowered by 10° C. down to 35° C. The stress value indicated in a recording meter was plotted relative to temperature as illustrated in FIG. 1. The intersection of line A determined from the points at 35° C., 45° C. and 55° C. by the least square method with line B determined from the points 105° C., 95° C. and 85° C. by the least square method was defined as the glass transition point (Tg) of a coating film.

The invention is characterized by that the glass transition point (Tg) of a coating film is adjusted to fall within a range of from 60 to 95° C., preferably from 70 to 95° C. Within this range, the coating film has an improved corrosion resistance, even though temperature values outside the range may be used, because transition frequency to a rubber region decreases and a corrosion forming substance does not transfer below the coating film, even if the coating film is heated.

When the glass transition point (Tg) of the coating film is less than 60° C., the coating film tends to transit to the rubber state and corrosion forming substance reaches below the coating film, leading to a deterioration in corrosion resistance. When the coating film has a glass transition point (Tg) exceeding 95° C., on the other hand, its exposure corrosion resistance tend to lower, because the film becomes hard and lowering in chipping resistance and increase in an internal stress occur.

Oxygen Permeability:

Oxygen permeability is an index of permeation of a corrosion forming substance through a coating film and invasion below the coating film. In the present invention, the coating film of a cationic coating composition has a glass transition point (Tg) of from 60 to 95° C., and an oxygen permeability, at a film thickness of 20 μm, of from 5×10⁻¹³ (cc·cm/cm²·sec·cmHg) to 5×10⁻¹¹ (cc·cm/cm²·sec·cmHg), preferably from 1×10⁻¹² (cc·cm/cm²·sec·cmHg) to 9×10⁻¹² (cc·cm/cm²·sec·cmHg). The coating film having such properties does not allow a corrosion forming substance to invade therethrough. The oxygen permeability is measured at 40° C.

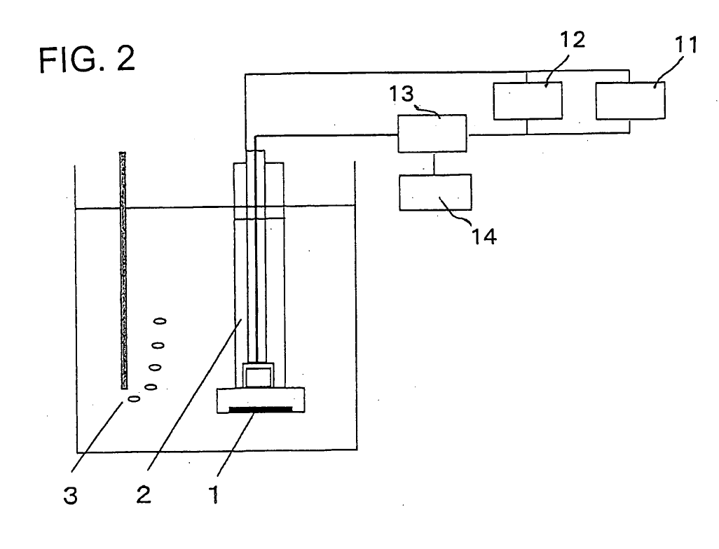

For the measurement of the oxygen permeability, a gas permeability analysis system (“EMD-05B”, manufactured by Denshi Kagaku) adopting a differential pressure method and using a GCMS (mass spectrometer) as a detector was employed. Details of the measurement is described in “Toryo no Kenkyu (Study of Coating Material),” Kansai Paint Giho, No. 122, pp. 9-17 (March 1993). As illustrated in the model of FIG. 2, a coating film 1 was attached to the end of an electrode kept within 5% KCl solution 2 and an amount of oxygen 3 passing through the coating film 1 was measured by means of an electric measurement circuit that consists of a battery 11, voltmeter 12, ammeter 13 and recording meter 14.

Improvement of corrosion resistance is conventionally known to depend on the glass transition point and inter-crosslinkage molecular weight. These characteristics have a close relation with the blocking of oxygen. In the present invention, the oxygen permeability is found to be an important property for imparting the coating film with an oxygen blocking function and in addition, preferable ranges of the glass transition point and oxygen permeability for attaining improvement of corrosion resistance are found.

Adhesive Force:

The adhesive force of the coating film, which has been obtained by applying a cationic coating composition to an object to be coated, within a range of 3.0 kg/cm² or greater, or more preferably within a range of 4.7 kg/cm² or greater, is preferred for improving corrosion resistance. As an evaluation method of adhesion between a coating film and an object to be coated, the pull-off method of measuring adhesive force by pulling a jig adhered to a coated test plate is employed for its convenience.

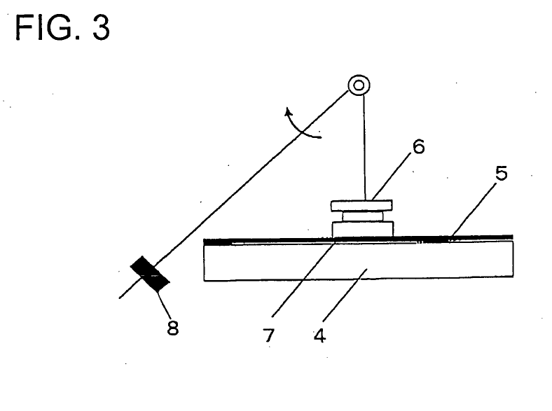

An adhered terminal is pulled using a Shopper tester or Instron type material tester. In the present invention, as illustrated in the model of FIG. 3, a measuring jig 6 (16 cm²) is bonded to a coating film 5 coated onto an object 4 with an instant adhesive 7, and the adhesive force is measured using a Shopper tester, to which a weight 8 is attached and a motion is given as shown in an arrow.

Examples of the object to be coated include cold-rolled steel sheet subjected to surface treatment such as phosphate treatment or chromate treatment, hot dip galvanized steel sheet, electrogalvanized steel sheet, electrolytic zinc-iron electroplated steel sheet, organic composite plated steel sheet and aluminum steel sheet. In the metal coating method of the present invention, a parkerized cold-rolled steel sheet ordinarily employed as an automotive steel sheet is used.

Although conventionally used resins can form a coating film having the above-described properties, that is, glass transition point (Tg) of from 60 to 95° C., oxygen permeability, at a film thickness of 20 μm, of from 5×10⁻¹³ (cc·cm/cm²·sec·cmHg) to 5×10⁻¹¹ (cc·cm/cm²·sec·cmHg), and an adhesive force of 3.0 kg/cm² or greater, more preferably, 4.7 kg/cm² or greater, the below-described base resins and curing agents are found to be more preferred.

In cationic coating compositions, amine-added epoxy resins are suited as a base resin from the viewpoint of corrosion resistance and block polyisocyanates having a cyclic structure are excellent as a curing agent so that they have been used popularly.

The epoxy resin used as a base resin in the present invention has, similar to the conventional base resin, preferably an average molecular weight of from 1,000 to 10,000, more preferably from 2,000 to 5,000. When the average molecular weight of the base resin exceeds 10,000, a resin viscosity increases and a deterioration in thermal fluidity upon baking leads to poor finish property of an electrodepositing coating film and less preferred. When the average molecular weight is less than 1,000, on the other hand, an amine number becomes hard to be adjusted easily by the amount of amine, leading to undesirable lowering in the dispersibility of the emulsion, and thus less preferred.

The amine compound to be added to the epoxy resin preferably contains a primary amino group and has an amine number ranging from 30 to 70 mgKOH/g resin solid content, preferably from 40 to 60 mgKOH/g resin solid content or less. The modification amount must be suppressed to the minimum amount necessary for plasticization and the amount is preferably from 5 to 50 parts by weight, more preferably from 10 to 30 parts by weight based on 100 parts by weight of the epoxy resin.

The base resin is preferably polarized inside thereof by using a hydrophobic modifier. Examples of such a base resin include xylene-formaldehyde-resin-modified amino-containing epoxy resins, polyol-modified amino-containing epoxy resins, and polyol-modified amino-containing epoxy resins added with an alkyl phenol and/or carboxylic acid, each obtained by reacting with an epoxy group by using a modifier as described above.

Base Resin (I)

The xylene-formaldehyde-resin-modified amino-containing epoxy resin is an amino-containing epoxy resin (which may hereinafter be called “base resin (I)”) obtained by reacting an epoxy resin (1) having an epoxy equivalent of from 180 to 2500 with a xylene formaldehyde resin (2) and an amino-containing compound (3).

As the epoxy resin (1) used as a starting material of the base resin, those available by the reaction between a polyphenol compound and an epihalohydrin, for example, epichlorohydrin are particularly suited from the viewpoint of the corrosion resistance of the coating film.

As the polyphenol compound to be used for the formation of the epoxy resin, those ordinarily employed can be used. Examples include bis(4-hydroxyphenyl)-2,2-propane (bisphenol A), 4,4-dihydroxybenzophenone, bis(4-hydroxyphenyl)methane (bisphenol F), bis(4-hydroxyphenyl)-1,1-ethane, bis(4-hydroxyphenyl)-1,1-isobutane, bis(4-hydroxy-tert-butyl-phenyl)-2,2-propne, bis(2-hydroxynaphthyl)methane, tetra(4-hydroxyphenyl)-1,1,2,2,-ethane, 4,4-dihydroxydiphenylsulfone (bisphenol S), phenol novolac and cresol novolac.

Among the epoxy resins available by the reaction between a polyphenol compound and epichlorohydrin, those derived from bisphenol A and represented by the following formula: 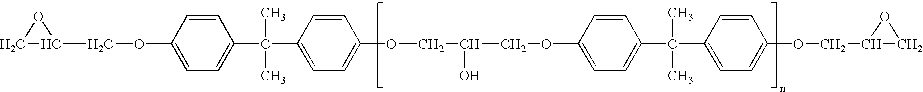
wherein n stands for 0 to 8 are preferred.

The epoxy resin (1) may have an epoxy equivalent usually from 180 to 2,500, preferably from 200 to 2,000, more preferably from 400 to 1,500. Those having a number-average molecular weight of usually at least 200, preferably within a range of from 400 to 4,000, more preferably from 800 to 2,500 are suited.

Examples of the commercially available epoxy resins satisfying the above-described properties include those marketed under the name of “Epikote 828EL, 1002, 1004 and 1007”, from Japan Epoxy Resin Co., Ltd.

The xylene formaldehyde resin (2) is useful for the internal plasticization (modification) of the epoxy resin (1). It can be prepared, for example, by condensation reaction of xylene and formaldehyde and optionally a phenol in the presence of an acid catalyst.

As the formaldehyde, compounds producing formaldehyde such as industrially easily available formalin, paraformaldehyde and trioxane can be used. When a polymer such as paraformaldehyde or trioxane is used herein, the amount of it should be specified based on one molecule of formaldehyde.

The above-described phenols embrace monovalent or divalent phenol compounds having two or three reaction sites. Specific examples include phenol, cresols, para-octylphenol, nonylphenol, bisphenol propane, bisphenol methane, resorcin, pyrocatechol, hydroquinone, para-tert-butylphenol, bisphenol sulfone, bisphenol ether and paraphenylphenol. They may be used either singly or in combination. Of these, phenol and cresols are particularly preferred.

Examples of the acid catalyst to be used for the condensation reaction of the above-described xylene and formaldehyde and optionally phenol include sulfuric acid, hydrochloric acid, paratoluenesulfonic acid and oxalic acid. Usually, sulfuric acid is particularly suited. The amount of the catalyst may fall within a range of from 10 to 50 wt. % as a concentration in an aqueous solution, because it is diluted with water in the aqueous formaldehyde solution.

The condensation reaction may be effected usually by heating to about 80 to about 100° C. at which reflux of xylene, phenol, water and formalin existing in the reaction system occurs and the reaction can be completed usually in about 2 to 6 hours.

The xylene formaldehyde resin is available by reacting xylene and formaldehyde and optionally phenol by heating in the presence of the acid catalyst under the above-described conditions.

The xylene formaldehyde resin thus obtained may have a viscosity usually within a range of from 20 to 50,000 centipoise (25° C.), preferably within a range of from 30 to 15,000 centipoise (25° C.). It preferably has a hydroxyl equivalent usually ranging from 100 to 50,000, especially from 200 to 10,000.

The amino-containing compound (3) is a component for introducing an amino group into the epoxy resin (1) to cationize it and that containing at least one active hydrogen which is to react with the epoxy resin is employed.

Examples of the amino-containing compound (3) used for such a purpose include mono- or di-alkylamines such as monomethylamine, dimethylamine, monoethylamine, diethylamine, monoisopropylamine, diisopropylamine, triisopropylamine, monobutylamine and dibutylamine; alkanolamines such as monoethanolamine, diethanolamine, mono(2-hydroxypropyl)amine, di(2-hydroxypropyl)amine, tri(2-hydroxypropyl)amine, monomethylaminoethanol, and monoethylaminoethanol; alkylene polyamines such as ethylenediamine, propylenediamine, butylenediamine, hexamethylenediamine, tetraethylenepentamine, pentaethylenehexamine, diethylaminopropylamine, diethylenetriamine and triethylenetetramine and these polyamines having ketimine introduced therein; alkyleneimines such as ethyleneimine and propyleneimine; and cyclic amines such as piperazine, morpholine and pyrazine.

The base resin (I) to be used as the resin component in the present invention can be prepared by reacting the epoxy resin (1) with the xylene formaldehyde resin (2) and the amino-containing compound (3) in a manner per se in the art.

Although the reaction of the epoxy resin (1) with the xylene formaldehyde resin (2) and amino-containing compound (3) may be effected in a desired order, it is usually preferred to react the epoxy resin (1) with the xylene formaldehyde resin (2) and amino-containing compound (3) simultaneously.

The above-described addition reaction may be performed usually in a proper solvent at from about 80 to about 170° C., preferably from about 90 to about 150° C. for about 1 to 6 hours, preferably for 1 to 5 hours. Examples of the solvent include hydrocarbons such as toluene, xylene, cyclohexane and n-hexane; esters such as methyl acetate, ethyl acetate and butyl acetate, ketones such as acetone, methyl ethyl ketone, methyl isobutyl ketone and methyl amyl ketone, amides such as dimethylformamide and dimethylacetamide, and alcohols such as methanol, ethanol, n-propanol and iso-propanol, and mixtures thereof.

The proportion of the reaction components in the above-described addition reaction is not strictly limited and can be changed as needed, depending on the using purpose of the coating composition. The appropriate proportion is within the below-described range based on the total solid content of the three components, that is, epoxy resin (1), xylene formaldehyde resin (2) and amino-containing compound (3).

Epoxy resin (1): usually from 50 to 90 wt. %, preferably from 50 to 85 wt. %, xylene formaldehyde resin (2): usually from 5 to 45 wt. %, preferably from 6 to 43 wt. %, and amino-containing compound (3): usually from 5 to 25 wt. %, preferably from 6 to 20 wt. %.

The using ratios outside the above-described range may deteriorate any of corrosion resistance, finish property and stability so they are not preferred.

A resin component obtained by reacting, with the epoxy resin (1), xylene formaldehyde resin (2) and amino-containing compound (3), a polyol compound (4) available by adding a caprolactone to a compound containing a plurality of active hydrogen groups can also be employed.

The polyol compound (4) is added for the purpose of internal plasticization (modification) of the above-described epoxy resin (1) and it is prepared by adding a caprolactone to a compound containing a plurality of active hydrogen groups.

The term “active hydrogen group” means an atomic group having at least one active hydrogen and it embraces, for example, alcoholic hydroxyl group, primary amino groups and secondary amino groups. Examples of the compound containing, in one molecule thereof, a plurality of active hydrogen groups include low-molecular-weight polyols, linear or branched polyether polyols, linear or branched polyester polyols, amino compounds having a primary amino group and/or a secondary amino group and hydroxylamine compounds having a primary amino group and/or a secondary amino group in combination with a hydroxyl group. The active-hydrogen-containing compound (a) may have a number-average molecular weight usually ranging from 62 to 5,000, preferably from 62 to 4,000, more preferably from 62 to 1,500. The active-hydrogen-containing compound (a) preferably has, in one molecule thereof, 2 or greater but less than 30, especially from 2 to 10 active hydrogen groups on average.

The above-described low-molecular-weight polyols (i) are each a compound having, in one molecule thereof, at least two alcoholic hydroxyl groups and specific examples include diols such as ethylene glycol, propylene glycol, 1,3-butylene glycol, 1,4-butanediol, 1,6-hexanediol, diethylene glycol, dipropylene glycol, cyclohexane-1,4-dimethylol, neopentyl glycol, triethylene glycol and hydrogenated bisphenol A; triols such as glycerin, trimethylolethane and trimethylolpropane; tetrols such as pentaerythritol and α-methylglucoxide; hexols such as sorbitol and dipentaerythritol; and octols such as sucrose.

The above-described linear or branched polyether polyols may each have a number average molecular weight usually ranging from 62 to 10,000, preferably from 62 to 2,000. Specific examples include polyethylene glycol, polypropylene glycol, polytetramethylene glycol, poly(ethylene-propylene)glycol, bisphenol A ethylene glycol ether and bisphenol A polypropylene glycol ether, each available by ring-opening addition reaction of an alkylene oxide (for example, ethylene oxide, propylene oxide, butylenes oxide, tetrahydrofuran, etc.).

The above-described linear or branched polyester polyols may each have a number average molecular weight of usually from 200 to 10,000, preferably from 200 to 3,000. Specific examples include those available by polycondensation reaction of an organic dicarboxylic acid or anhydride thereof with an organic diol under excessive amount of the organic diol.

Examples of the organic dicarboxylic acid to be used in the above reaction include aliphatic, alicyclic or aromatic dicarboxylic acids having from 2 to 44 carbon atoms, especially from 4 to 36 carbon atoms, for example, succinic acid, adipic acid, azelaic acid, sebacic acid, maleic acid, fumaric acid, glutaric acid, hexachloroheptanedicarboxylic acid, cyclohexanedicarboxylic acid, o-phthalic acid, isophthalic acid, terephthalic acid, tetrahydrophthalic acid, and tetrachlorophthalic acid. In addition to these dicarboxylic acids, a small amount of anhydride of a polycarboxylic acid having at least 3 carboxyl groups, adducts of an unsaturated. fatty acid and the like can be used in combination.

Examples of the organic diol component include alkylene glycols such as ethylene glycol, propylene glycol, butylene glycol, 1,4-butanediol, 1,6-hexanediol and neopentyl glycol, and dimethylolcyclohexane. They may be used in combination with a small amount of a polyol such as trimethylolpropane, glycerin or pentaerythritol, if necessary.

Examples of the above-mentioned amine compound containing a primary amino group and/or a secondary amino group or amine compounds containing a primary amino group and/or a secondary amino group in combination with a hydroxyl group include alkylamines such as butylenediamine, hexamethylenediamine, tetraethylenepentamine, and pentaethylenehexamine; alkanolamines such as monoethanolamine, diethanolamine, triethanolamine, mono(2-hydroxypropyl)amine, and di(2-hydroxypropyl)amine; alicyclic polyamines such as 1,3-bisaminomethylcyclohexanone, and isophoronediamine; aromatic polyamines such as xylylenediamine, meta-xylenediamine, diaminodiphenylmethane, and phenylenediamine; alkylenepolyamines such as ethylenediamine, propylenediamine, diethylenetriamine, and triethylenetetramine; and amine adducts with a polyamide, polyamidoamine or epoxy compound which are derived from piperazine or the above-described polyamines, and the other amine compounds such as ketimine and aldimine.

Of the above-described compounds containing a plurality of active hydrogen groups, those selected from the group consisting of ethylene glycol, propylene glycol, butylenes glycol, 1,4-butanediol, 1,6-hexanediol, diethylene glycol, hydrogenated bisphenol A, glycerin, trimethylolethane, trimethylolpropane, pentaerythritol, dipentaerythritol, polyethylene glycol, polypropylene glycol, polytetramethylene glycol, poly(ethylene-propylene)glycol, bisphenol A ethylene glycol ether, bisphenol A polypropylene glycol ether, butylenediamine, hexamethylenediamine, monoethanolamine, diethanolamine, triethanolamine, isophoronediamine, ethylenediamine, propylenediamine, diethylenetriamine and triethylenetetramine are preferred.

On the other hand, as the caprolactone which can be added to the compound containing a plurality of active hydrogen groups, γ-caprolactone, ε-caprolactone, and δ-caprolactone can be given as examples, with ε-caprolactone being especially preferred.

The addition reaction of the compound containing a plurality of active hydrogen groups and the caprolactone can be performed in a manner known per se in the art. More specifically, it can be conducted by heating the compound containing a plurality of active hydrogen groups and the caprolactone at about 100 to about 250° C. for about 1 to about 15 hours in the presence of a catalyst, for example, a titanium compound such as tetrabutoxytitanium or tetrapropoxytitanium, an organic tin compound such as tin octylate, dibutyltin oxide or dibutyltin laurate; or a metal compound such as stannous chloride.

The amount of the catalyst may usually be from 0.5 to 1,000 ppm based on the total amount of the compound containing a plurality of active hydrogen groups and caprolactone. The caprolactone may be used within a range of usually from 1 to 30 moles, preferably from 1 to 20 moles, more preferably from 1 to 15 moles per equivalent of an active hydrogen group (that it, per active hydrogen) of the compound containing a plurality of active hydrogen groups.

The polyol compound (4) thus obtained has a high plasticizing performance attributable to the compound containing a plurality of active hydrogen groups, high compatibility with the epoxy resin attributable to the (poly)caprolactone and high reactivity attributable to the terminal hydrogen group so that it is very useful as an internal plasticizer of an epoxy resin for paint.

The polyol compound (4) may contain units derived from the caprolactone in a total amount of usually from 20 to 95 wt. %, preferably from 25 to 90 wt. % and it may have a number-average molecular weight usually ranging from 300 to 10,000, preferably from 400 to 5,000.

The resin having the polyol compound (4) as an additional reaction component can be prepared in a similar manner to that described above. It is usually preferred to react the epoxy resin (1) with the xylene formaldehyde resin (2), amino-containing compound (3) and polyol compound (4) simultaneously.

No strict limitation is imposed on the proportion of the reaction components in the above-described reaction and it can be changed as needed, depending on the using purpose of the cationic coating composition. The proportions of the epoxy resin (1), xylene formaldehyde resin (2), amino-containing compound (3) and polyol compound (4) preferably fall within the below-described ranges based on the total solid content of these four components.

epoxy resin (1): usually, from 50 to 85 wt. %, preferably from 50 to 80 wt. %,

xylene formaldehyde resin (2): usually, from 5 to 45 wt. %, preferably from 6 to 40 wt. %,

amino-containing compound (3): usually from 5 to 25 wt. %, preferably from 6 to 20 wt. %,

polyol compound (4); usually from 1 to 20 wt. %, preferably from 2 to 15 wt. %. The proportions outside the above-described ranges are not preferred, because they lead to a deterioration in any of corrosion resistance, finish property and stability.

The addition reaction of the amino-containing compound (3) and xylene formaldehyde resin (2), and/or polyol compound (4) to the epoxy resin (1) may be performed usually in a proper solvent at from about 80 to about 170° C., preferably from about 90 to about 150° C. for about 1 to 6 hours, preferably from 1 to 5 hours.

Examples of the solvent used in the above reaction include hydrocarbons such as toluene, xylene, cyclohexane and n-hexane; esters such as methyl acetate, ethyl acetate and butyl acetate, ketones such as acetone, methyl ethyl ketone, methyl isobutyl ketone and methyl amyl ketone, amides such as dimethylformamide and dimethylacetamide, and alcohols such as methanol, ethanol, n-propanol and iso-propanol, and mixtures thereof.

No strict limitation is imposed on the proportion of the above-described modifier and it can be changed as needed, depending on the using purpose of the coating composition or the like. The appropriate proportion ranges from 5 to 50 wt. %, preferably from 10 to 30 wt. % based on the solid content of the epoxy resin. When the proportion is less than the above-described range, an amount of a neutralizer for the resin must be increased. Proportions exceeding the above-described range lower the water dispersion stability and are therefore unsuited.

Base Resin (II)

As the base resin in the cationic coating composition, it is possible to use, instead of the xylene-formaldehyde-resin-modified amino-containing epoxy resin, a polyol-modified amino-containing epoxy resin (which may hereinafter be abbreviated as “base resin (II)”) obtained by reacting an epoxy resin (1) having an epoxy equivalent of from 180 to 2500 with a polyol compound (4) available by adding a caprolactone to a compound containing a plurality of active hydrogen groups, and an amino-containing compound (3).

As the epoxy resin (1), an epoxy resin similar to that employed in the preparation of the base resin (I) can be used.

The polyol compound (4) is used for internal plasticization (modification) of the epoxy resin (1) and can be prepared by adding a caprolactone to a compound containing a plurality of active hydrogen groups. A polyol compound similar to that used in the preparation of the base resin (1) can be employed.

The polyol compound (4) may contain units derived from a caprolactone in an amount usually ranging from 20 to 95 wt. %, preferably from 25 to 90 wt. % as. It may have a number average molecular weight of usually from 300 to 10,000, preferably from 400 to 5,000.

The amino-containing compound (3): The amino-containing compound (3) to be reacted with the epoxy resin (1) in the present invention is a cationizing component of the epoxy resin by introducing an amino group into the epoxy resin base. As the amino-containing compound, that having at least one active hydrogen which will react with an epoxy group is employed. An amino-containing compound similar to that employed in the preparation of the base resin (I) can be used.

In the cationic coating composition, the base resin (II) is available by addition reaction of the amino-containing compound (3) and the polyol compound (4) having a terminal hydroxyl group derived from a caprolactone to the epoxy resin (1) in a manner known per se in the art.

The reaction of the epoxy resin (1) with the polyol compound (4) and amino-containing compound (3) may be effected in a desired order, but usually it is preferred to react the epoxy resin (1) with the amino-containing compound (3) and polyol compound (4) simultaneously. The base resin thus obtained preferably has a terminal of the polyol compound (4) added to the backbone of the epoxy resin (1).

The above-described addition reaction may be carried out usually in a proper solvent at about 90 to about 170° C., preferably at about 100 to about 150° C. for about 1 to 5 hours, preferably for 2 to 4 hours. Examples of the solvent include hydrocarbons such as toluene, xylene, cyclohexane and n-hexane; esters such as methyl acetate, ethyl acetate and butyl acetate, ketones such as acetone, methyl ethyl ketone, methyl isobutyl ketone and methyl amyl ketone, amides such as dimethylformamide and dimethylacetamide, and alcohols such as methanol, ethanol, n-propanol and iso-propanol, and mixtures thereof.

The proportion of the reaction components in the above-described addition reaction is not strictly limited and can be changed as needed, depending on the using purpose of the coating composition or the like. The appropriate proportions are within the below-described ranges based on the total solid content of the three components, that is, epoxy resin (1), amino-containing compound (3) and polyol compound (4).

Epoxy resin (1): usually, from 60 to 90 wt. %, preferably from 62 to 85 wt. %, more preferably from 62 to 80 wt. %;

Amino-containing compound (3): usually from 5 to 25 wt. %, preferably from 6 to 19 wt. %, more preferably from 6 to 18 wt. %; and

Polyol compound (4); usually from 5 to 30 wt. %, preferably from 5 to 20 wt. %, more preferably from 5 to 18 wt. %.

The proportions outside the above-described ranges are not preferred, because they lead to a deterioration in any of corrosion resistance, finish property and stability.

Base Resin (III):

As the base resin in the cationic coating composition, it is possible to use, instead of base resin (I) and base resin (II), a polyol-modified amino-containing epoxy resin added with an alkyl phenol and/or a carboxylic acid (which resin may hereinafter be abbreviated as “base resin (III)”) obtained by reacting an epoxy resin (1) with an alkyl phenol (v₁) and/or a carboxylic acid (v₂), an amino-containing compound (3), and a polyol compound (4) available by adding a caprolactone to a compound containing a plurality of active hydrogen groups.

As the epoxy resin (1), an epoxy resin similar to that employed in the preparation of the base resin (I) or base resin (II) can be used.

An alkyl phenol in an alkylphenol and/or a carboxylic acid is represented by the following formula (1): 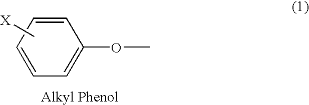
(wherein, X represents a hydrogen atom or a C₁₋₁₅ hydrocarbon group which may have a substituent selected from the group consisting of —OH, —OR, —SH and —SR, in which R represents an alkyl group).

In the above-described formula (1), the C₁₋₁₅ hydrocarbon group represented by X may be any one of linear, branched and cyclic groups and of these, C₁₋₁₅, especially C₁₋₁₂ alkyl groups, for example, methyl, ethyl, n-propyl, isopropyl, n-butyl, tert-butyl and nonyl groups are preferred. These groups may be substituted with a substituent selected from the group consisting of a hydroxyl group (—OH), alkoxy groups (—OR), a mercapto group (—SH) and alkylthio groups (—SR).

Specific examples of the alkyl phenols represented by the formula (1) include phenol, cresol, ethylphenol, para-tert-butylphenol and nonylphenol.

The carboxylic acid is at least one compound selected from the group consisting of carboxylic acids represented by the following chemical formula (2): 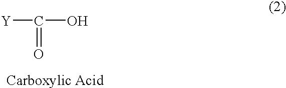
(wherein, Y represents a C₁₋₁₅ hydrocarbon group which may have a substituent selected from the group consisting of —OH, —OR, —SH and —SR, in which R represents an alkyl group).

In the above-described chemical formula (2), the C₁₋₁₅ hydrocarbon group represented by Y may be linear, branched or cyclic. Specific examples include alkyl groups such as methyl, ethyl, n-propyl, isopropyl, n-butyl and nonyl, alkenyl groups such as vinyl and oleyl and aryl groups such as phenyl. These groups may be substituted by at least one, preferably 1 to 3 substituents selected from the group consisting of hydroxyl group, alkoxy groups, mercapto group and alkylthio groups. Examples of the hydrocarbon group substituted with such a substituent include 1-hydroxyethyl, 1,1-dimethylolethyl, 1,1-dimethylolpropyl and 3,4,5-trihydroxyphenyl groups.

Specific examples of the compound represented by the chemical formula (2) include acetic acid, propionic acid, butyric acid, valeric acid, acrylic acid, oleic acid, glycolic acid, glyceric acid, lactic acid, dimethylolpropionic acid, dimethylolbutyric acid, dimethylolvaleric acid, benzoic acid and gallic acid. Of these, acetic acid, propionic acid, butyric acid, oleic acid, dimethylolpropionic acid, dimethylolbutyric acid, dimethylolvaleric acid and benzoic acid are preferred.

The polyol compound (4) is a polyol obtained by adding a caprolactone to a compound having a plurality of active hydrogen groups. A polyol compound similar to that used for the base resin (I) or base resin (II) can be employed.

As the amino-containing compound (3), an amino-containing compound similar to that used for the base resin (I) or (II) can be employed. Specific examples include alkylamines such as monomethylamine, dimethylamine, monoethylamine, diethylamine, monoisopropylamine, diisopropylamine, monobutylamine, dibutylamine, butylenediamine, hexamethylenediamine, tetraethylenepentamine, pentaethylenehexamine, and diethylaminopropylamine; and monoethanolamine, diethanolamine, mono(2-hydroxypropyl)amine, and di(2-hydroxypropyl)amine and these polyamine compounds having ketimine introduced therein.

Such a polyol compound (4) has, at one end thereof, a polycaprolactone-derived hydroxyl group and has a high plasticizing performance attributable to the polyol, a high compatibility with the epoxy resin attributable to the polycaprolactone, and a high reactivity attributable to the end hydroxyl group so that it has improved adhesion and permeation inhibiting performance. The addition of it therefore contributes to an improvement in corrosion resistance.

The base resin (III) contains the above-described components, based on the total solid content of them, in the below-described ranges, respectively: epoxy resin (1) within a range of from 60 to 85 wt. %, the alkyl phenol and/or carboxylic acid within a range of from 2 to 15 wt. %, the amino-containing compound (3) within a range of from 5 to 25 wt. % and the polyol compound (4), which is available by adding a caprolactone to a compound having a plurality of active hydrogen groups, within a range of from 5 to 20 wt. %. Proportions outside the above-described ranges lead to a deterioration in any of corrosion resistance, finish property and stability.

Curing Agent (I):

In addition to the base resin, the cationic coating composition may contain, as a curing agent, a blocked polyisocyanate compound obtained by blocking the isocyanate group of a polyisocyanate compound with a blocking agent.

As the curing agent, either one of aromatic or alicyclic isocyanate can be used, but that having, in one molecule thereof, at least 1.5, especially 2 to 3 ring structures on average is preferred. Examples of the isocyanate compounds particularly preferred as a raw material include diphenylmethane diisocyanate and hydrogenated diphenylmethane diisocyanate.

Specific examples of such a polyisocyanate include diphenylmethane-2,4′- and/or -4,4′-diisocyanate (which is usually called “MDI”), crude MDI and hydrogenated MDI, and adducts thereof with a polyol, adducts of tolylene diisocyanate, xylylene diisocyanate or phenylene diisocyanate with a polyol, adducts of isophorone diisocyanate or bis(isocyanatomethyl)cyclohexane with a polyol, and isocyanurate compounds such as tetramethylene diisocyanate and hexamethylene diisocyanate. Of these, crude MDI and hydrogenated MDI are particularly preferred as the polyisocyanate compound.

As the blocking agent, preferred is a blocking agent which is to be added to the isocyanate group of a polyisocyanate compound to block it. The block polyisocyanate compound obtained by the addition reaction is stable at normal temperature. It preferably undergoes dissociation when heated to the baking temperature (usually, about 100 to 200° C.) of a coating film to release the isocyanate group as a free one.

Examples of the blocking agent include lactam compounds such as ε-caprolactam and γ-butyrolactam; oxime compounds such as methyl ethyl ketoxime and cyclohexanone oxime; phenol compounds such as phenol, para-t-butylphenol and cresol; aliphatic alcohols such as n-butanol and 2-ethylhexanol; aromatic alkyl alcohols such as phenylcarbinol and methylphenylcarbinol; and ether alcohols such as ethylene glycol monobutyl ether and diethylene glycol monoethyl ether.

Curing Agent (II):

The cationic coating composition may contain a curing agent (II) obtained by reacting a polyisocyanate compound with an active-hydrogen-containing component further containing propylene glycol and an aromatic polyisocyanate compound.

Examples include alcohol compounds containing a primary and secondary or primary and tertiary hydroxyl groups such as propylene glycol, dipropylene glycol, 1,3-butanediol, 1,2-butanediol, 3-methyl-1,2-butanediol, 1,2-pentanediol, 1,4-pentanediol, 3-methyl-4,3-pentanediol, 3-methyl-4,5-pentanediol, 2,2,4-trimethyl-1,3-pentanediol, 1,4-hexanediiol and 1,5-hexanediol.

Of these, those having a low molecular weight and a high dissociation property are preferred as the blocking agent. Use of propylene glycol which is an alcohol compound containing primary and secondary hydroxyl groups and methyl ethyl ketoxime which is an oxime compound are especially preferred for diphenylmethane diisocyanate and hydrogenated diphenylmethane diisocyanate, respectively.

In the cationic electcrodeposition coating, the base resin is added in an amount ranging usually from 55 to 90 wt. %, preferably from 65 to 80 wt. % and the curing agent is added in an amount ranging usually from 10 to 45 wt. %, preferably from 20 to 35 wt. %, each based on the total solid content of these two components.

The cationic electrodeposition coating containing the base resin and block polyisocyanate curing agent can be prepared by fully mixing the base resin and block polyisocyanate curing agent, neutralizing the resulting mixture with a water soluble organic carboxylic acid usually in an aqueous medium and solubilizing or dispersing the epoxy resin in water.

As the organic carboxylic acid for neutralization, acetic acid and formic acid, and mixture thereof are particularly preferred. By the use of such an acid, the film thus formed has improved corrosion resistance and finish property, and the coating composition has improved stability.

No particular limitation is imposed on a pigment to be used in the cationic coating composition in the metal coating method of the present invention insofar as it is a pigment conventionally employed for cationic electrodeposition coatings. Examples include coloring pigments such as titanium oxide, carbon black and iron oxide red, extender pigments such as clay, mica, baryta, calcium carbonate and silica, and rust inhibitive pigments such as aluminum phosphomolybdate and aluminum tripolyphosphate.

In addition, a bismuth compound can be incorporated in order to improve corrosion resistance. Examples include bismuth oxide, bismuth hydroxide, basic bismuth carbonate, bismuth nitrate, bismuth silicate, and organic acid bismuth compounds each prepared by reacting at least two organic acids with a bismuth compound as described above and having an aliphatic hydroxycarboxylic acid as at least one of the organic acids.

The pigment may be added in an amount of from 1 to 100 parts by weight, especially from 10 to 50 parts by weight based on 100 parts by weight of the total solid content of the base resin and curing agent.

The cationic coating composition may further contain a curing catalyst and a precipitation inhibitor as needed. The curing catalyst is effective for promoting the crosslinking reaction between the base resin and the curing agent. Examples include dioctyltin oxide, dibutyltin oxide, tin octoate, dibutyltin dilaurate, dibutyltin dibenzoate, zinc octylate and zinc formate. It is preferably added in an amount of from 0.1 to 10 parts by weight, based on 100 parts by weight of the total amount of the base resin and curing agent.

The cationic coating composition is preferably obtained by preparing the above-described pigment paste in advance, and mixing it with a emulsion having the base resin and curing agent dispersed therein.

Objects to be coated with the cationic coating composition thus obtained include automotive bodies and parts which use a metal as a base material. From the viewpoint of corrosion resistance, corrosion-resistant steel sheets are suited. By the metal coating method according to the present invention, coated articles having excellent corrosion resistance can be obtained.

Examples of the corrosion resistant steel sheets include hot-dip galvanized steel sheet, electrogalvanized steel sheet, zinc-iron electroplated steel sheet, organic composite plated steel sheet and aluminum steel sheet and these steel sheets or cold-rolled steel sheets subjected to surface treatment such as parkerizing treatment or chromate treatment after cleansing their surfaces by alkaline degreasing as needed.

The metal coating method found according to the present invention can provide coated articles excellent in corrosion resistance when the coating film obtained by the cationic coating composition containing the base resin and curing agent has the following physical properties: a glass transition point (Tg) of from 60 to 95° C., and an oxygen permeability, at a film thickness of 20 μm, of from 5×10⁻¹³ (cc·cm/cm²·sec·cmHg) to 5×10⁻¹¹ (cc·cm/cm²·sec·cmHg) and, more preferably, an adhesive force of 3.0 kg/cm² or greater.

As the base resin, xylene-formaldehyde-resin-modified amino-containing epoxy resin, polyol-modified amino-containing epoxy resin, and polyol-modified amino-containing epoxy resin obtained by reacting with an alkyl phenol and/or carboxylic acid are preferred.

As the curing agent, as well as the conventionally employed block polyisocyanate compounds, a block polyisocyanate obtained by reacting an aromatic polyisocyanate compound with polypropylene glycol as a blocking agent is preferred and by the addition of it, these physical properties of the coating film fall within the above-described ranges.

### EXAMPLES

Examples and Comparative Examples of the present invention will hereinafter be described. All designations of “part” or “parts” and “%” mean part or parts by weight and wt. %. It should however be borne in mind that the present invention is not limited only to these Examples.

### Preparation Example 1

### Preparation of Xylene Formaldehyde Resin 1

In a separable flask having an internal capacity of 2 liters and equipped with a thermometer, a reflux condenser and a stirrer, 240 g of 50% formalin, 55 g of phenol, 101 g of 98% industrial sulfuric acid and 212 g of metaxylene were charged and they were reacted at 84 to 88° C. for 4 hours. After completion of the reaction, the reaction mixture was allowed to stand to separate it into a resin phase and a sulfuric acid aqueous phase. The resin phase was washed three times with water, followed by stripping of unreacted metaxylene for 20 minutes under the conditions of from 20 to 30 mmHg and from 120 to 130° C., whereby Xylene formaldehyde resin 1 having a viscosity of 1050 centipoise (at 25° C.) was obtained.

### Preparation of Base Resin

### Preparation Example 2

### Preparation of Base Resin No. 1 (Base Resin (I) Type)

In a flask were added 1000 g of “Epikote 828EL” (trade name of epoxy resin, product of Japan Epoxy Resin Co., Ltd., epoxy equivalent: 190, molecular weight: 350), 400 g of bisphenol A and 0.2 g of dimethylbenzylamine and they were reacted at 130° C. until the epoxy equivalent became 750.

Next, 300 g of Xylene formaldehyde resin 1 obtained in Preparation Example 1, 140 g of diethanolamine and 65 g of ketimine-introduced diethylenetriamine were added, followed by reaction at 120° C. for 4 hours. To the reaction mixture was added 420 g of butyl cellosolve, whereby xylene-formaldehyde-resin-modified amino-containing epoxy resin having an amine number of 52 and a resin content of 80% was obtained as Base resin No. 1.

### Preparation Example 3

### Preparation of Base Resin No. 2 (Base Resin (I) Type)

To 400 g of “PP-400” (trade name of polypropylene glycol produced by Sanyo Chemical Industries, Ltd., molecular weight: 400) was added 300 g of ε-caprolactone and the mixture was heated to 130° C. Tetrabutoxytitanium (0.01 g) was then added and the mixture was heated to 170° C. While keeping this temperature, the reaction mixture was sampled time-dependently. The amount of the unreacted εo-caprolactone was traced by measuring infrared absorption spectrum and when the reaction ratio reached 98% or greater, the reaction mixture was cooled, whereby Modifier 1 was obtained.

In another flask, 1000 g of “Epikote 828EL” (trade name of epoxy resin produced by Japan Epoxy Resins Co. Ltd., epoxy equivalent: 190, molecular weight: 350), 400 g of bisphenol A and 0.2 g of dimethylbenzylamine were added. They were reacted at 130° C. until the epoxy equivalent became 750.

Then, 200 g of Xylene formaldehyde resin 1 in the liquid form, which had been obtained in Preparation Example 1, 100 g of Modifier 1, 140 g of diethanol and 65 g of ketimine-introduced diethylenetriamine were added. After reaction at 120° C. for 4 hours, 420 g of butyl cellosolve was added, whereby a xylene-formaldehyde-resin-modified amino-containing epoxy resin having an amine number of 52 and a resin content of 80% was obtained as Base resin No. 2.

### Preparation Example No. 4

### Base Resin No. 3 (Base Resin (II) Type)

To 400 g of “PP-400” (trade name of polypropylene glycol produced by Sanyo Chemical Industries, Ltd., molecular weight: 400) was added 300 g of ε-caprolactone and the mixture was heated to 130° C. Tetrabutoxytitanium (0.01 g) was then added and the mixture was heated to 170° C. While keeping this temperature, the reaction mixture was sampled time-dependently. The amount of the unreacted ε-caprolactone was traced by measuring infrared absorption spectrum and when the reaction ratio reached 98% or greater, the reaction mixture was cooled, whereby Modifier 1 was obtained.

In another flask, 1000 g of “Epikote 828EL” (trade name of epoxy resin produced by Japan Epoxy Resins Co. Ltd., epoxy equivalent: 190, molecular weight: 350), 400 g of bisphenol A and 0.2 g of dimethylbenzylamine were added. They were reacted at 130° C. until the epoxy equivalent became 750. After 200 g of Modifier 1, 140 g of diethanolamine and 65 g of ketimine-introduced diethylenetriamine were added to the reaction mixture and they were reacted at 120° C. for 4 hours, 400 g of butyl cellosolve was added, whereby a polyol-modified amino-containing epoxy resin having an amine number of 56 and a resin content of 80% was obtained as Base resin No. 3.

### Preparation Example 5

### Base Resin No. 4 (Base Resin (III) Type)

To 400 g of “PP-400” (trade name of polypropylene glycol produced by Sanyo Chemical Industries, Ltd., molecular weight: 400) was added 300 g of ε-caprolactone and the mixture was heated to 130° C. Tetrabutoxytitanium (0.01 g) was then added and the mixture was heated to 170° C. While keeping this temperature, the reaction mixture was sampled time-dependently. The amount of the unreacted ε-caprolactone was traced by measuring infrared absorption spectrum and when the reaction ratio reached 98% or greater, the reaction mixture was cooled, whereby Modifier 2 was obtained.

In another flask, 1000 g of “Epikote 828EL” (trade name of epoxy resin produced by Japan Epoxy Resins Co., Ltd., epoxy equivalent: 190, molecular weight: 350), 400 g of bisphenol A and 0.2 g of dimethylbenzylamine were added. They were reacted at 130° C. until the epoxy equivalent became 750.

To the reaction mixture was added 120 g of nonylphenol and they were reacted at 130° C. until the epoxy equivalent became 1000. After 200 g of Modifier 2, 95 g of diethanolamine and 65 g of ketimine-introduced diethylenetriamine were added to the reaction mixture and they were reacted at 120° C. for 4 hours, 414 g of butyl cellosolve was added, whereby a nonylphenol-added polyol-modified amino-containing epoxy resin having an amine number of 40 and a resin content of 80% was obtained as Base resin No. 4.

### Preparation Example 6

### Base Resin No. 5 (Base Resin (III) Type)

To 1000 g of “Epikote 828EL” (trade name of epoxy resin produced by Japan Epoxy Resins Co., Ltd., epoxy equivalent: 190, molecular weight: 350) were added 400 g of bisphenol A and 0.2 g of dimethylbenzylamine and the mixture was reacted at 130° C. until the epoxy equivalent became 750.

Benzoic acid (61 g) was then added to the reaction mixture and they were reacted at 130° C. until the epoxy equivalent became 1000.

After 200 g of Modifier 2 obtained as in Preparation Example 5, 95 g of diethanolamine and 65 g of ketimine-introduced diethylenetriamine were added to the reaction mixture and they were reacted at 120° C. for 4 hours, 400 g of butyl cellosolve was added, whereby a benzoic-acid-added polyol-modified amino-containing epoxy resin having an amine number 41 and a resin solid content of 80% was obtained as Base resin No. 5.

### Preparation Example 7

### Base Resin No. 6

In 546 parts of butyl cellosolve was dissolved 1900 parts of “EPON 1004” (trade name of bisphenol A type epoxy resin having an epoxy equivalent of about 950, produced by Japan Epoxy Resins Co. Ltd.). After dropwise addition of 124 parts of diethylamine at 80 to 100° C., the reaction mixture was kept at 120° C. for 2 hours, whereby an epoxy-resin-amine adduct having an amine number of 47 was obtained.

Then, 1000 parts of a dimer acid type polyamide resin (“VERSAMID 460”, trade name; product of Henkel Hakusui Co., Ltd.) having an amine number of 100 was dissolved in 210 parts of methyl isobutyl ketone. The resulting solution was heated under reflux at 130 to 150° C. Water thus generated was distilled off and the terminal amino group of the amide resin was converted to ketimine. The resulting compound was maintained at 150° C. for about 3 hours. After termination of the distillation of water, the residue was cooled to 60° C. and added to the epoxy resin-amine adduct. The resulting mixture was heated to 100° C. After the mixture was maintained for 1 hour, it was cooled to room temperature, whereby an amino-containing epoxy resin, which is an epoxy-resin-amino-polyamide-added resin, having an amine number of 65 and a solid content of 80% was obtained as Base resin No. 6.

### Preparation of Curing Agent

### Preparation Example 8

### Preparation of Blocked Polyisocyanate Curing Agent (No. 1)

To 270 g of “Cosmonate M-200” (trade name of crude MDI; product of Mitsui Takeda Chemical) was added 46 g of methyl isobutyl ketone. The resulting mixture was heated to 70° C. To the reaction mixture was added 46 g of diethylene glycol monoethyl ether, followed by heating to 70° C. After addition of 281 g of diethylene glycol monoethyl ether in portions, the reaction mixture was heated to 90° C.

While keeping the temperature, sampling was conducted time-dependently. By confirming the disappearance of the absorption of unreacted isocyanate by infrared absorption spectrum, the solvent amount was adjusted, whereby a blocked polyisocyanate curing agent No. 1 having a solid content of 90% was obtained.

### Preparation Example 9

### Curing Agent (No. 2)

“COSMONATE M-200” (270 parts) and 25 parts of methyl isobutyl ketone were added to a reaction vessel. The resulting mixture was heated to 70° C. After 15 parts of 2,2-dimethylbutane was added in portions and 118 parts of ethylene glycol monobutyl ether was added dropwise, the mixture was reacted at 70° C. for 1 hour. The reaction mixture was cooled and 152 parts of propylene glycol was added thereto.

While keeping the temperature, sampling was conducted time-dependently. The disappearance of the absorption of unreacted isocyanate was confirmed by infrared absorption spectrum, whereby a curing agent No. 2 having a solid content of 90% was obtained.

### Preparation Example 10

### Curing Agent 3

A curing agent No. 3 having a solid content of 90% was obtained by adding dropwise 174 parts of methyl ethyl ketoxime to 222 g of isophorone diisocyanate and 44 g of methyl isobutyl ketone at 50° C.

### Preparation of Emulsion for Cationic Coating Composition

### Preparation Example 11

### Emulsion No. 1

After uniformly stirring a mixture of 87.5 parts (70 parts in terms of a resin content) of Base resin No. 1, 33.3 g (30 g in terms of a resin content) of Curing agent No. 1 and 13 parts of 10% acetic acid, deionized water was added dropwise in about 15 minutes while vigorously stirring the reaction mixture, whereby Emulsion No. 1 having a solid content of 34% was obtained.

### Preparation Examples 12 to 20

Emulsions No. 2 to No. 10 were obtained in a similar manner to that employed in Preparation Example 11 except for the use of the compositions as shown in Table 1 instead.

TABLE 1
Emulsion Composition

| | | | | | | | | | | | Prep. |
|---|---|---|---|---|---|---|---|---|---|---|---|
| | | Prep. | Prep. | Prep. | Prep. | Prep. | Prep. | Prep. | Prep. | Prep. | EX. |
| | | Ex. | Ex. | Ex. | Ex. | Ex. | Ex. | Ex. | Ex. | Ex. | 20 |
| | | 11 | 12 | 13 | 14 | 15 | 16 | 17 | 18 | 19 | No. |
| Emulsion | | No. 1 | No. 2 | No. 3 | No. 4 | No. 5 | No. 6 | No. 7 | No. 8 | No. 9 | 10 |
| Composition | Base resin No. 1 (solid | 87.5 | | | | | 87.5 | 87.5 | | | |
| | content: 80%) | (70) | | | | | (70) | (70) | | | |
| | Xylene formaldehyde | | | | | | | | | | |
| | resin | | | | | | | | | | |
| | Base resin No. 2 (solid | | 87.5 | | | | | | | | |
| | content: 80%) | | (70) | | | | | | | | |
| | Xylene formaldehyde | | | | | | | | | | |
| | resin | | | | | | | | | | |
| | Base resin No. 3 (solid | | | 87.5 | | | | | | | |
| | content: 80%) | | | (70) | | | | | | | |
| | Polyol-modified Ep | | | | | | | | | | |
| | Base resin No. 4 (solid | | | | 87.5 | | | | | | |
| | content: 80%) | | | | (70) | | | | | | |
| | Nonylphenol-added | | | | | | | | | | |
| | polyol modified Ep | | | | | | | | | | |
| | Base resin No. 5 (solid | | | | | 87.5 | | | | | |
| | content: 80%) | | | | | (70) | | | | | |
| | Benzoic-acid-added | | | | | | | | | | |
| | polyol-modified Ep | | | | | | | | | | |
| | Base resin No. 6 (solid | | | | | | | | 87.5 | 87.5 | 87.5 |
| | content: 80%) | | | | | | | | (70) | (70) | (70) |
| | Amine-added Ep | | | | | | | | | | |
| | Curing agent No. 1 | 33.3 | 33.3 | 33.3 | 33.3 | 33.3 | | | 33.3 | | |
| | (solid content: 90%) | (30) | (30) | (30) | (30) | (30) | | | (30) | | |
| | (Crude MDI) | | | | | | | | | | |
| | Curing Agent No. 2 | | | | | | 33.3 | | | 33.3 | |
| | (solid content: 90%) | | | | | | (30) | | | (30) | |
| | (Crude MDI-PG block) | | | | | | | | | | |
| | Curing agent No. 3 | | | | | | | 33.3 | | | 33.3 |
| | (solid content: 90%) | | | | | | | (30) | | | (30) |
| | (IPDI-Ox) | | | | | | | | | | |
| | 10% acetic acid | 13 | 13 | 13 | 13 | 13 | 13 | 13 | 13 | 13 | 13 |
| | Deionized water | 160.2 | 160.2 | 160.2 | 160.2 | 160.2 | 160.2 | 160.2 | 160.2 | 160.2 | 160.2 |

| | | | | | | | | | | |
|---|---|---|---|---|---|---|---|---|---|---|
| 34% Emulsion | 294 | 294 | 294 | 294 | 294 | 294 | 294 | 294 | 294 | 294 |
| | (100) | (100) | (100) | (100) | (100) | (100) | (100) | (100) | (100) | (100) |

### Preparation of Pigment-Dispersed Paste

### Preparation Example 21

### Pigment-Dispersed Paste No. 1

A mixture of 5.83 parts (solid content: 3.5 parts) of an epoxy quaternary-ammonium type dispersing resin having a solid content of 60%, 14.5 parts of titanium oxide, 7.0 parts of purified clay, 1.0 part of bismuth hydroxide, 1.0 part of organic tin, 0.4 part of carbon black and 20.1 parts of deionized water was dispersed in a ball mill for 20 hours. The dispersion was taken out from the ball mill as Pigment dispersed paste No. 1 having a solid content of 55%.

### Preparation Example 22

### Pigment Dispersed Paste No. 2

A mixture of 5.83 parts (solid content: 3.5 parts) of an epoxy quaternary-ammonium type dispersing resin having a solid content of 60%, 14.5 parts of titanium oxide, 7.0 parts of purified clay, 3.0 parts of bismuth hydroxide, 1.0 part of organic tin, 0.4 part of carbon black and 21.8 parts of deionized water was dispersed in a ball mill for 20 hours. The dispersion was taken out from the ball mill as Pigment dispersed paste No. 2 having a solid content of 55%.

TABLE 2
Composition of Pigment Dispersed Paste

| | Preparation | Preparation |
|---|---|---|
| | Example 21 | Example 22 |
| Pigment dispersed paste | No. 1 | No. 2 |
| Epoxy quaternary ammonium | 5.83 | 5.83 |
| type dispersing resin | (3.5) | (3.5) |
| Titanium oxide | 14.5 | 14.5 |
| Purified clay | 7 | 7 |
| Bismuth hydroxide | 1 | 3 |
| Dioctyltin oxide | 1 | 1 |
| Carbon black | 0.4 | 0.4 |
| Deionized water | 20.1 | 21.8 |
| Solid content: 55% | 49.8 | 53.5 |
| | (27.4) | (29.4) |

### EXAMPLES AND COMPARATIVE EXAMPLES

### Example 1

To 297 parts (solid content: 100 parts) of Emulsion No. 1 (Base resin No. 1, Curing agent No. 1) were added 49.8 parts (solid content: 27.4 parts) of Pigment-dispersed paste No. 1 and 290 parts of deionized water to prepare Cationic coating No. 1 having a solid content of 20%.

### Examples 2 to 7 and Comparative Examples 1 to 3

In a similar manner to Example 1 except for the use of compositions shown in Table 3 instead, Cationic coatings No. 2 to No. 10 were prepared, respectively. Compositions and test results of Cationic coatings No. 1 to No. 10 are shown in Table 3.

TABLE 3
Compositions of Cationic Coatings.Properties of Coating Film.Test Results

| | | | | | | | | | | | Comp. |
|---|---|---|---|---|---|---|---|---|---|---|---|
| | | | | | | | | | Comp. | Comp. | Ex. 3 |
| | | Ex. 1 | Ex. 2 | Ex. 3 | Ex. 4 | Ex. 5 | Ex. 6 | Ex. 7 | Ex. 1 | Ex. 2 | NO. |
| Cationic coating | | No. 1 | No. 2 | No. 3 | NO. 4 | NO. 5 | No. 6 | No. 7 | No. 8 | No. 9 | 10 |
| Composition | Emulsion No. 1 (Base resin No. | 297 | | | | | | | | | |
| | 1, Curing agent No. 1) | | | | | | | | | | |
| | Emulsion No. 2 (Base resin No. | | 297 | | | | | | | | |
| | 2, Curing agent No. 1) | | | | | | | | | | |
| | Emulsion No. 3 (Base resin No. | | | 297 | | | | | | | |
| | 3, Curing agent No. 2) | | | | | | | | | | |
| | Emulsion No. 4 (Base resin No. | | | | 297 | | | | | | |
| | 4, Curing agent No. 1) | | | | | | | | | | |
| | Emulsion No. 5 (Base resin No. | | | | | 297 | | | | | |
| | 5, Curing agent No. 1) | | | | | | | | | | |
| | Emulsion No. 6 (Base resin No. | | | | | | 297 | | | | |
| | 1, Curing agent No. 2) | | | | | | | | | | |
| | Emulsion No. 7 (Base resin No. | | | | | | | 297 | | | |
| | 1, Curing agent No. 3) | | | | | | | | | | |
| | Emulsion No. 8 (Base resin No. | | | | | | | | 297 | | |
| | 6 Curing agent No. 1) | | | | | | | | | | |
| | Emulsion No. 9 (Base resin No. | | | | | | | | | 297 | |
| | 6, Curing agent No. 2) | | | | | | | | | | |
| | Emulsion No. 10 (Base resin | | | | | | | | | | 297 |
| | No. 6, Curing agent No. 3) | | | | | | | | | | |
| | Pigment-dispersed paste No. 1 | 49.8 | 49.8 | 49.8 | 49.8 | 49.8 | 49.8 | 49.8 | | 49.8 | |
| | Pigment-dispersed paste No. 2 | | | | | | | | 53.5 | | 53.5 |
| | Deionized water | 290 | 290 | 290 | 290 | 290 | 290 | 290 | 290 | 296 | 296 |
| | 20% Cationic coating | 637 | 637 | 637 | 637 | 637 | 637 | 637 | 637 | 647 | 647 |
| Properties | Glass transition point (° C.) *2 | 80 | 82 | 78 | 82 | 85 | 72 | 65 | 55 | 56 | 48 |
| of coating | Oxygen permeability *3 (×10⁻¹²) | 4.1 | 5.6 | 6.2 | 5.8 | 5.3 | 8.1 | 11.5 | 56.2 | 58.5 | 60.3 |
| film | cc · cm/cm² · sec · cmHg | | | | | | | | | | |
| | Adhesion (kg/cm²) *4 | 5.1 | 5.0 | 4.8 | 4.8 | 4.7 | 3.5 | 3.1 | 2.7 | 2.8 | 2.3 |
| Test | Corrosion resistance *5 | A | A | A | A | A | B | B | B | B | C |
| results | Resistance against hot salt- | A | A | A | A | A | A | A | B | B | C |
| | water immersion *6 | | | | | | | | | | |
| | Exposure corrosion resistance | A | A | A | A | A | A | A | A | A | B |
| | *7 | | | | | | | | | | |
| | Finish property (horizontal | A | A | A | A | A | A | A | B | A | B |
| | surface) *8 | | | | | | | | | | |

(*2): Glass transition point: Each cationic coating was applied to a tin plate, followed by baking at 170° C. for 20 minutes to give a film thickness of 20 μm. The coating film was peeled off by the amalgam method and it was cut into a strip 5 mm wide.

Then, the test piece was attached to “RS-20C model” (trade name of glass transition point measuring apparatus, manufactured by RETHKA) so that the length of a portion to be measured became 20 mm. The glass transition point was measured. As illustrated in FIG. 1, the glass transition point (Tg) was determined by the least square method.
(*3) Oxygen permeability: Each cationic coating was applied to a tin plate, followed by baking at 170° C. for 20 minutes to give a film thickness of 20 μm. The coating film was peeled off by the amalgam method and it was cut into a piece having a diameter of 18 mmφ. The piece was attached to a measuring cell.

Then, oxygen permeability was measured at 40° C. by using a gas permeability analysis meter (“EMD05B”, manufactured by Denshi Kagaku) adopting the differential pressure system and using GCMS (mass spectrometer) as a detector (refer to FIG. 2)
(*4) Adhesion: Adhesive force was measured five times by a jig and Shopper tester as illustrated in FIG. 3 and an average was defined as adhesive force.
(*5) Corrosion resistance: Each cationic coating was applied to a parkerized SPCC steel sheet of 70 mm×150 mm so that the film thickness after baking at 170° C. for 20 minutes became 20 μm. After washing with water, the sheet was baked at 170° C. for 20 minutes. The resulting steel sheet was crosscut by a cutter knife and salt spray test at 35° C. was conducted for 840 hours. The sheet was then tape-peeled for evaluation.

A: a width peeled by the tape is less than 2 mm

B: a width peeled by the tape is 2 mm or greater but less than 3 mm which is a permissible range

C: a width peeled by the tape is 3 mm or greater but less than 4 mm

D: a width peeled by the tape is 4 mm or greater
(*6): Resistance against hot salt water immersion: Each cationic coating was applied to an untreated cold-rolled steel sheet of 70 mm×150 mm by electrodeposition under the conditions permitting formation of a film having a thickness of 20 μm after baking at 170° C. for 20 minutes. After washing with water, the coating film obtained by baking at 170° C. for 20 minutes was immersed in salt water of 50° C. After 480 hours test, the whole surface of the steel sheet was subjected to tape peeling and evaluated.

A: A percentage of the coating film peeled by the tape is less than 10% of the whole area of the sheet.

B: A percentage of the coating film peeled by the tape is 10% to 20% of the whole area of the sheet

C: A percentage of the coating film peeled by the tape exceeds 20%
(*7) Exposure corrosion resistance: Each cationic coating was applied to a parkerized cold-rolled steel sheet of 70 mm×150 mm under the conditions permitting the formation of a coating film having a film thickness of 20 μm after baking at 170° C. for 20 minutes. After washing with water, baking at 170° C. for 20 minutes was conducted. An intermediate coating “TP-65-2” was applied to give a film thickness of 35 μm, followed by baking at 140° C. for 20 minutes. Then, “Neoamylac 6000 (white)” was applied to give a film thickness of 35 μm, followed by baking at 140° C. for 20 minutes.

The resulting sheet was crosscut by a cutter knife and subjected to exposure test for 1 year at Chikura-cho (Chiba Prefecture).

A: The width of rust or blister from the cut line is within 3 mm (one side)

B: The width of rust or blister from the cut line is 3 to 4 mm (one side)

C: The width of rust or blister from the cut line exceeds 4 mm (one side)
(*8) Finish property (horizontal surface): Each cationic coating was filled in a test tank and it was applied horizontally to a parkerized cold-rolled steel sheet of 70 mm×150 mm under the conditions permitting the formation of a coating film having a film thickness of 20 μm. After washing with water, it was baked at 170° C. for 20 minutes and surface condition was observed.

A: good without luster loss, seeding, cissing and cratering.

B: lowering in finish property owing to luster loss, seeding, cissing and cratering is observed.

C: considerable lowering in the finish property owing to luster loss, seeding, cissing and cratering is observed.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

The disclosure of Japanese Patent Application No. 2002-344540 filed Nov. 27, 2002 including specification, drawings and claims is incorporated herein by reference in its entirety.

1. A metal coating method excellent in corrosion resistance comprising:
using a cationic coating composition containing a base resin and a curing agent; and
forming a film having a glass transition point (Tg) of from 60 to 95° C., and an oxygen permeability of from 5×10⁻¹³ (cc·cm/cm²·sec·cmHg) to 5×10⁻¹¹ (cc·cm/cm²·sec·cmHg) at a film thickness of 20 μm;
wherein the base resin is selected from the group consisting of
(A) a base resin (I) comprising a xylene-formaldehyde-resin-modified amino-containing epoxy resin obtained by reacting an epoxy resin (1) having an epoxy equivalent of from 180 to 2500 with a xylene formaldehyde resin (2) and an amino-containing compound (3),
(B) a base resin (II) comprising a polyol-modified amino-containing epoxy resin obtained by reacting an epoxy resin (1) having an epoxy equivalent of from 180 to 2500 with an amino-containing compound (3), and a polyol compound (4) available by adding a caprolactone to a compound having a plurality of active hydrogen groups, and
(C) a base resin (III) comprises a polyol-modified amino-containing epoxy resin (III) obtained by reacting an epoxy resin (1) having an epoxy equivalent of from 180 to 2500 with an alkyl phenol (v₁) and/or a carboxylic acid (v₂), an amino-containing compound (3) and a polyol compound (4) available by adding a caprolactone to a compound having a plurality of active hydrogen groups.

2. A metal cotain method excellent in corrosion resistance according to claim 1,
wherein the curing agent (I) comprises a blocked polyisocyanate compound obtained by blocking an isocyanate group of a polyisocyanate compound with a blocking agent.

3. A metal coating method excellent in corrosion resistance according to claim 1, wherein the curing agent is a block polyisocyanate curing agent (II) obtained by reacting an active-hydrogen-containing component further containing propylene glycol with an aromatic polyisocyanate compound and is incorporated as the whole or portion of the curing agent (II) of the cationic coating composition.

4. A metal coating method excellent in corrosion resistance according to claim 1, wherein the cationic coating composition is applied to an object to be coated to form a film having an adhesive force of 3.0 kg/cm² or greater.

5. A metal coating method excellent in corrosion resistance according claim 1, wherein the cationic coating composition used for the metal coating method contains at least one bismuth compound.

6. A coated article obtained by the metal coating method as claimed in claim 1.

7. A coated article obtained by the metal coating method as claimed in claim 2.

8. A coated article obtained by the metal coating method as claimed in claim 3.

9. A coated article obtained by the metal coating method as claimed in claim 4.

10. A coated article obtained by the metal coating method as claimed in claim 5.
